(19) United States
(12) Patent Application Publication
(10) Pub. No.: US 2021/0049322 A1
(43) Pub. Date: Feb. 18, 2021

(54) INPUT ERROR DETECTION DEVICE, INPUT ERROR DETECTION METHOD, AND COMPUTER READABLE MEDIUM

(71) Applicant: MITSUBISHI ELECTRIC CORPORATION, Tokyo (JP)

(72) Inventors: Ryosuke SHIMABE, Tokyo (JP); Takeshi ASAI, Tokyo (JP); Kiyoto KAWAUCHI, Tokyo (JP)

(73) Assignee: MITSUBISHI ELECTRIC CORPORATION, Tokyo (JP)

(21) Appl. No.: 17/071,038

(22) Filed: Oct. 15, 2020

Related U.S. Application Data
(63) Continuation of application No. PCT/JP2018/020172, filed on May 25, 2018.

(51) Int. Cl. G06F 40/232; G06F 40/226; G06F 40/12; G06K 9/00; G06K 9/72

(52) U.S. Cl. CPC G06F 40/232; G06F 40/226; G06K 9/72; G06K 9/00442; G06F 40/12

(57) ABSTRACT

In an input error detection device (100), a selection unit (108) selects a group of words that appear common to a system specification document (117) describing a specification of an information system in a natural language, and an analysis object document (116) describing at least either one of analysis device input information (111) being input information to an analysis device that analyzes the information system, and analysis device output information (112) being output information from the analysis device, in a natural language. A learning unit (109) learns a meaning of an individual word in each of the system specification document (117) and the analysis object document (116), wherein the individual word belongs to the group of words selected by the selection unit (108). A detection unit (110) detects a change, between the system specification document (117) and the analysis object document (116), in meaning learned by the learning unit (109), so as to identify a word error being included in the analysis object document (116) and resulting from an input error of the analysis device input information (111).

### CROSS REFERENCE TO RELATED APPLICATIONS

This application is a Continuation of PCT International Application No. PCT/JP2018/020172, filed on May 25, 2018, which is hereby expressly incorporated by reference into the present application.

### TECHNICAL FIELD

The present invention relates to an input error detection device, an input error detection method, and an input error detection program.

### BACKGROUND ART

The TF-IDF scheme is widely known as a scheme to calculate an importance of a word, as described in Patent Literature 1. Note that TF stands for Term Frequency, and that IDF stands for Inverse Document Frequency.

### CITATION LIST

### Patent Literature

Patent Literature 1: JP 2009-064191 A

### SUMMARY OF INVENTION

### Technical Problem

In general, most devices that require input information from a user are equipped with functions of detecting input errors. In a simple specific example, often, a function of deciding an error between a full-size character and a half-size character, or a spelling error, a function of deciding a total number of characters or a total amount of money, or the like is implemented as one function of an input interface.

An element that appears to be an input error is detected by such an input error decision technique and is notified to the user by an alert message or the like. As a result, the user can notice the input error and generate accurate input information again.

A conventional input error detection function as described above requires a rule prepared to detect an input error, that is, requires an input error detection rule. Therefore, when installing an input error detection function in a device, a developer of the device in advance must analyze conditions under which an input error occurs, taking into account a content and format of input information, and generate an input error detection rule.

The common conventional input error detection scheme involves an issue that the developer of the analysis device must generate an input error detection rule depending on the format of the input information to the analysis device.

The same issue exists in an information system automatic analysis device. An automatic information system analysis device is a system device as a whole that is provided with a function of assessing a state of the system using an existing analysis scheme, in order to reduce the working cost in a design process and a development process of an information system, or in order to improve a performance, security, and so on of the system. The information system to be analyzed may be an information system that is designed or developed, or may be an information system that is already in operation for a specific purpose, regardless of whether the information system is for an personal use or an organization use.

The input information to the analysis device is selected according to the purpose of the analysis. If the analysis is about the development cost, information concerning the apparatus cost and human cost is selected. If the analysis is about cyber-attack resistance or about a security measure, information concerning vulnerability in the apparatus and security function setting of the apparatus is selected as the input information. The selected information is formulated as information having a format such as a text, numeral values, and images, or as information having a combined format of a text, numeral values, and images, whichever is required by the analysis device. Therefore, the developer of the information system automatic analysis device also must generate an input error detection rule depending on the format of the input information.

The present invention has as its objective to provide an input error detection scheme that does not depend on a format of input information and does not require an input error detection rule.

### Solution to Problem

An input error detection device includes:
a selection unit to select a group of words that appear common to a system specification document describing a specification of an information system in a natural language, and an analysis object document describing at least either one of input information to an analysis device that analyzes the information system and output information from the analysis device in a natural language;
a learning unit to learn a meaning of an individual word in each of the system specification document and the analysis object document, wherein the individual word belongs to the group of words selected by the selection unit; and
a detection unit to detect a change, between the system specification document and the analysis object document, in meaning learned by the learning unit, so as to identify a word error being included in the analysis object document and resulting from an input error of the input information.

### Advantageous Effects of Invention

In the present invention, a meaning of an individual word belonging to a group of words that appear common to a system specification document and an analysis object document is learned. Then, by detecting a change in the learned meaning between the system specification document and the document analysis object document, an error in the word included in the analysis object document and resulting from an input error of input information is identified. Therefore, according to the present invention, an input error detection scheme can be provided that does not depend on a format of the input information and does not require an input error detection rule.

### BRIEF DESCRIPTION OF DRAWINGS

FIG. 1 is a block diagram illustrating a configuration of an input error detection device according to Embodiment 1.

FIG. 2 is a block diagram illustrating a configuration of a verbalization unit of the input error detection device according to Embodiment 1.

FIG. 3 is a block diagram illustrating a configuration of a selection unit of the input error detection device according to Embodiment 1.

FIG. 4 is a block diagram illustrating a configuration of a learning unit of the input error detection device according to Embodiment 1.

FIG. 5 is a block diagram illustrating a configuration of a detection unit of the input error detection device according to Embodiment 1.

FIG. 6 is a flowchart illustrating operations of the input error detection device according to Embodiment 1.

FIG. 7 is a flowchart illustrating operations of the verbalization unit of the input error detection device according to Embodiment 1.

FIG. 8 is a flowchart illustrating operations of the selection unit of the input error detection device according to Embodiment 1.

FIG. 9 is a flowchart illustrating operations of the learning unit of the input error detection device according to Embodiment 1.

FIG. 10 is a flowchart illustrating operations of the detection unit of the input error detection device according to Embodiment 1.

### DESCRIPTION OF EMBODIMENTS

An embodiment of the present invention will now be described with referring to drawings. In the drawings, the same or equivalent portion is denoted by the same reference sign. In the description of the embodiment, explanation on the same or equivalent portion will be appropriately omitted or simplified. Note that the present invention is not limited to the embodiment described below, and various changes can be made to the present invention as necessary. For example, the embodiment to be described below may be practiced only partly.

### Embodiment 1

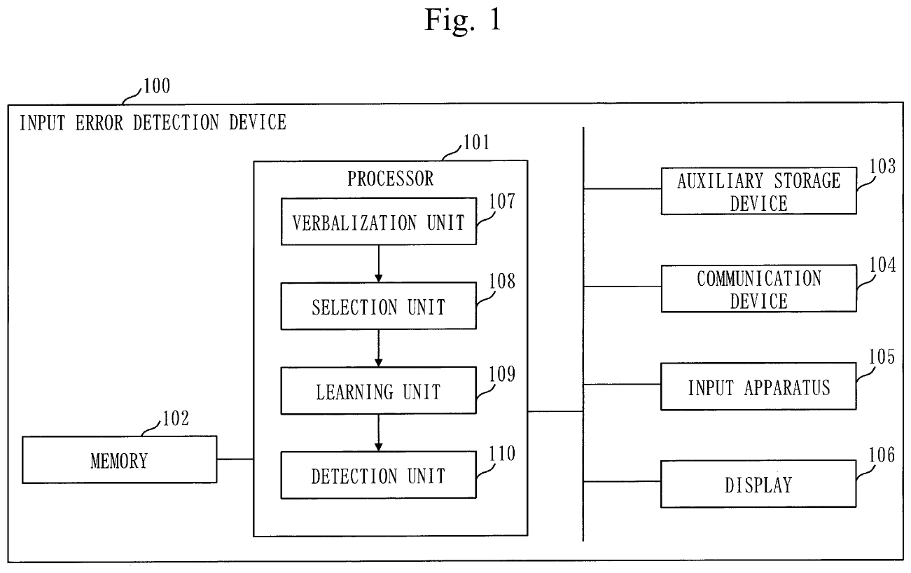

The present embodiment will be described with referring to FIGS. 1 to 10.

***Description of Configuration***

A configuration of an input error detection device 100 according to the present embodiment will be described with referring to FIG. 1.

The input error detection device 100 is a computer. The input error detection device 100 is provided with a processor 101, and is provided with other hardware devices such as a memory 102, an auxiliary storage device 103, a communication device 104, an input apparatus 105, and a display 106. The processor 101 is connected to the other hardware devices via signal lines and controls these other hardware devices.

The input error detection device 100 is provided with a verbalization unit 107, a selection unit 108, a learning unit 109, and a detection unit 110, as function elements. Functions of the verbalization unit 107, selection unit 108, learning unit 109, and detection unit 110 are implemented by software. Specifically, the functions of the verbalization unit 107, selection unit 108, learning unit 109, and detection unit 110 are implemented by an input error detection program. The input error detection program is a program that causes the computer to execute a process performed by the verbalization unit 107, a process performed by the selection unit 108, a process performed by the learning unit 109, and a process performed by the detection unit 110, respectively as a verbalization process, a selection process, a learning process, and a detection process. The input error detection program may be recorded on a computer readable medium and provided in the form of the medium, may be stored in a recording medium and provided in the form of the recording medium, or may be provided as a program product. The input error detection program may be stored in a portable recording medium such as a magnetic disk and an optical disk.

The processor 101 is a device that executes the input error detection program. The processor 101 is, for example, a CPU. Note that CPU stands for Central Processing Unit.

The memory 102 and the auxiliary storage device 103 are devices that store the input error detection program. The memory 102 is, for example, a RAM or a flash memory; or a combination of a RAM and a flash memory. Note that RAM stands for Random-Access Memory. The auxiliary storage device 103 is, for example, an HDD or a flash memory; or a combination of an HDD and a flash memory. Note that HDD stands for Hard Disk Drive.

The communication device 104 is provided with a receiver to receive data to be inputted to the input error detection program, and a transmitter to transmit data outputted from the input error detection program. The communication device 104 is, for example, a communication chip or an NIC. Note that NIC stands for Network Interface Card.

The input apparatus 105 is an apparatus that is operated by a user in order to input data to the input error detection program. The input apparatus 105 is, for example, a mouse, a keyboard, or a touch panel; or a combination of some or all of a mouse, a keyboard, and a touch panel.

The display 106 is an apparatus that displays data outputted from the input error detection program onto a screen. The display 106 is, for example, an LCD. Note that LCD stands for Liquid Crystal Display.

The input error detection program is loaded from the auxiliary storage device 103 to the memory 102, is read by the processor 101, and is executed by the processor 101. Not only the input error detection program but also an OS is stored in the auxiliary storage device 103. Note that OS stands for Operating System. The processor 101 executes the input error detection program while executing the OS. The input error detection program may be incorporated in the OS partly or entirely.

The input error detection device 100 may be provided with a plurality of processors that substitute for the processor 101. The plurality of processors share execution of the input error detection program. Each processor is, for example, a CPU.

Data, information, signal values, and variable values that are utilized, processed, or outputted by the input error detection program are stored in the memory 102, the auxiliary storage device 103, or a register or cache memory in the processor 101.

The input error detection device 100 may be constituted of one computer, or may be constituted of a plurality of computers. When the input error detection device 100 is constituted of a plurality of computers, the functions of the verbalization unit 107, selection unit 108, learning unit 109, and detection unit 110 may be implemented by the individual computers through distribution.

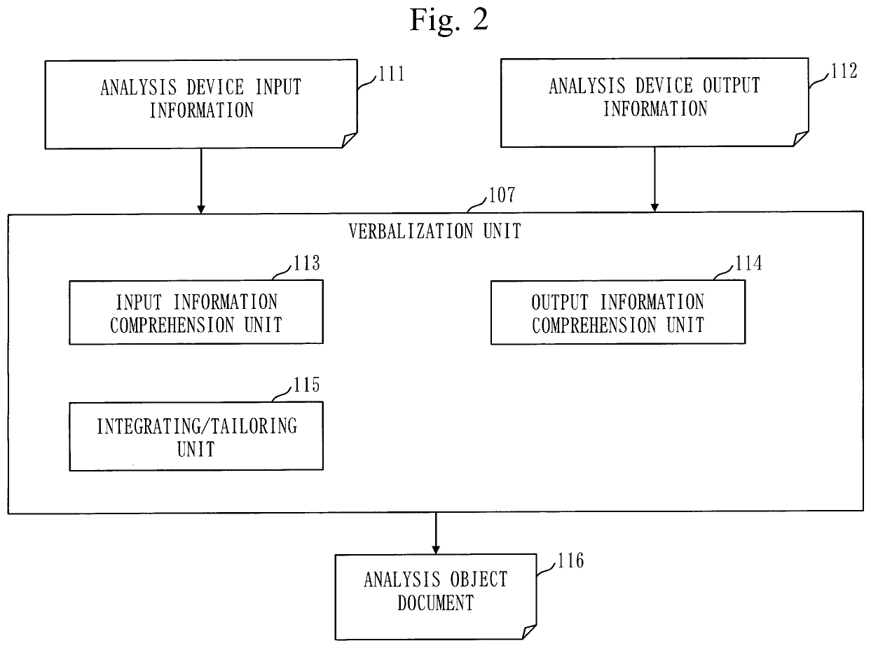

A configuration of the verbalization unit 107 will be described with referring to FIG. 2.

The verbalization unit 107 is provided with an input information comprehension unit 113, an output information comprehension unit 114, and an integrating/tailoring unit 115.

The verbalization unit 107 has a function of generating an analysis object document 116 described in a natural language, the analysis object document 116 being information concerning a system to be analyzed and obtained from at least either one of an analysis device input information 111 and an analysis device output information 112, put together.

The analysis device input information 111, which is input data of an information system automatic analysis device, and the analysis device output information 112, which is output data of the information system automatic analysis device, are inputted via the communication device 104. Alternatively, the analysis device input information 111 and the analysis device output information 112 may be stored in the memory 102 or the auxiliary storage device 103 in advance.

The analysis object document 116 generated by the verbalization unit 107 is stored in the memory 102, the auxiliary storage device 103, or a register or cache memory in the processor 101. Alternatively, the analysis object document 116 may be stored in a portable recording medium such as a magnetic disk and an optical disk.

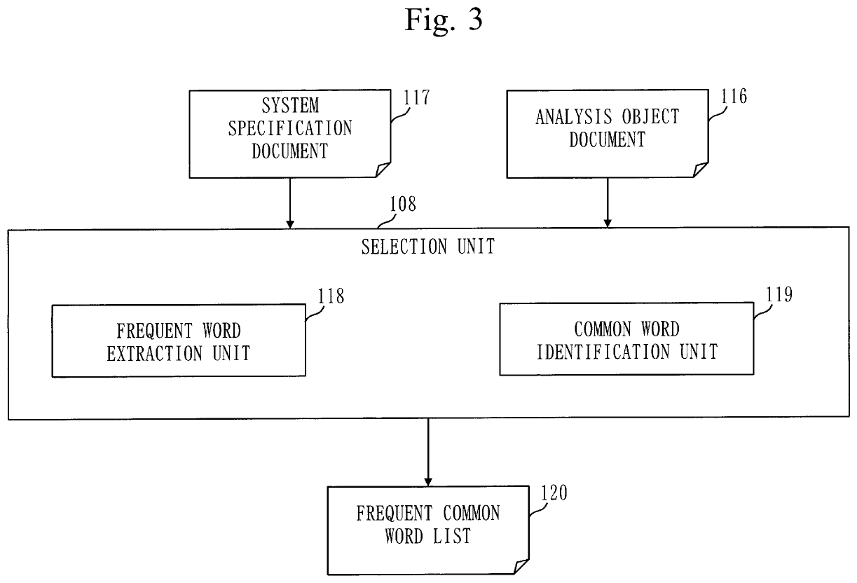

A configuration of the selection unit 108 will be described with referring to FIG. 3.

The selection unit 108 is provided with a frequent word extraction unit 118 and a common word identification unit 119.

The selection unit 108 has a function of searching a system specification document 117 and the analysis object document 116 which is stored in the memory 102, the auxiliary storage device 103, or the register or cache memory in the processor 101, to find a word that frequently appears common to sentences in the analysis object document 116 and system specification document 117, and generating a frequent common word list 120.

The system specification document 117 is inputted via the communication device 104. Alternatively, the system specification document 117 may be stored in the memory 102 or the auxiliary storage device 103 in advance.

As the frequent common word list 120, a fixed word list prepared in advance may be used. Alternatively, a particular word may be added to the frequent common word list 120 generated by the selection unit 108.

The frequent common word list 120 generated by the selection unit 108 is stored in the memory 102, the auxiliary storage device 103, or the register or cache memory in the processor 101. Alternatively, the frequent common word list 120 may be stored in a portable recording medium such as a magnetic disk and an optical disk.

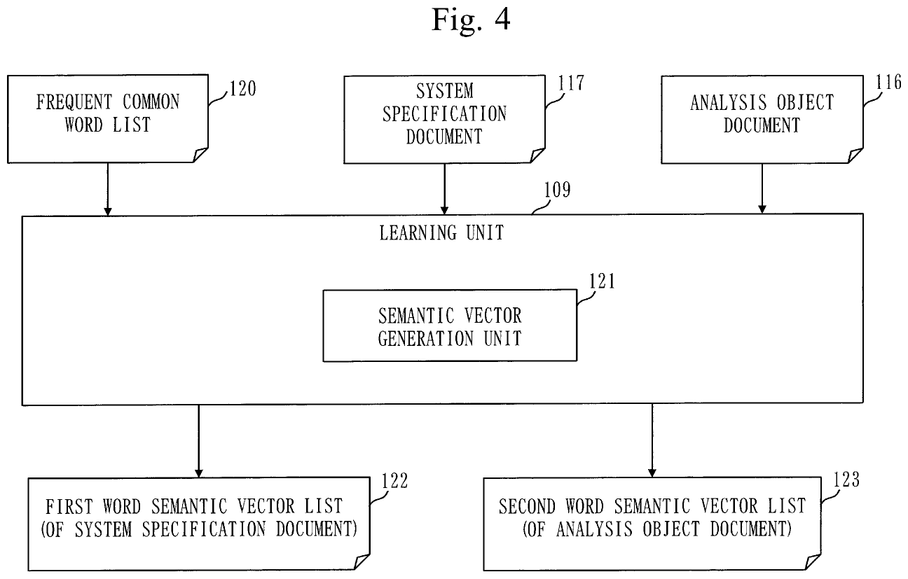

A configuration of the learning unit 109 will be described with referring to FIG. 4.

The learning unit 109 is provided with a semantic vector generation unit 121.

The learning unit 109 has a function of giving a semantic vector which is based on a distributional hypothesis to be described later, to every word in the frequent common word list 120 stored in the memory 102, the auxiliary storage device 103, or the register or cache memory in the processor 101.

There are two types of semantic vectors to be given to a word. A first type is a first word semantic vector list 122 learned from the system specification document 117. A second type is a second word semantic vector list 123 learned from the analysis object document 116.

The first word semantic vector list 122 and the second word semantic vector list 123 are stored in the memory 102, the auxiliary storage device 103, or the register or cache memory in the processor 101, in such a format that it is possible to decide uniquely a meaning of which word in the frequent common word list 120 each vector represents. Alternatively, the first word semantic vector list 122 and the second word semantic vector list 123 may be stored in a portable recording medium such as a magnetic disk and an optical disk.

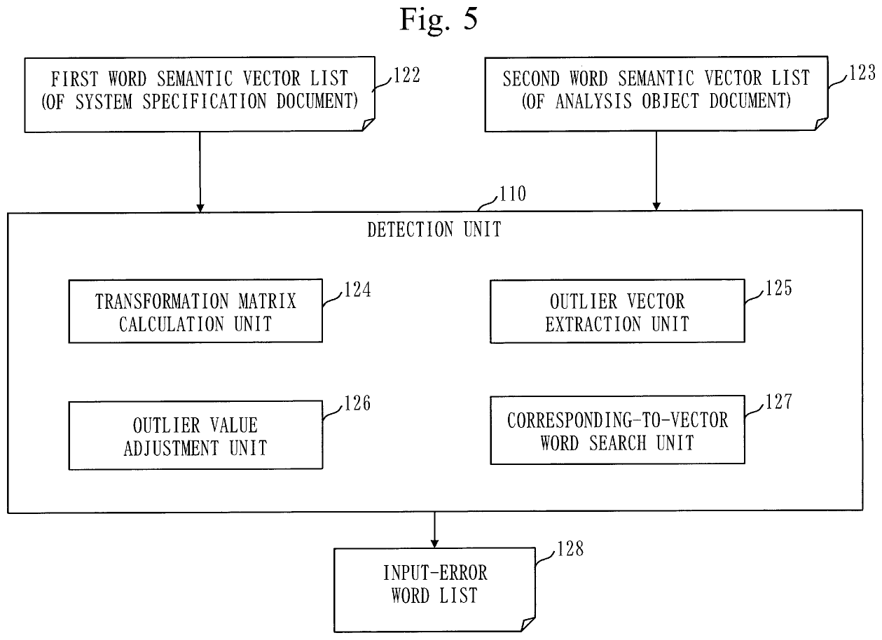

A configuration of the detection unit 110 will be described with referring to FIG. 5.

The detection unit 110 is provided with a transformation matrix calculation unit 124, an outlier vector extraction unit 125, an outlier value adjustment unit 126, and a corresponding-to-vector word search unit 127.

The detection unit 110 has a function of finding a transformation matrix U of a dual word semantic vector for the same word with respect to the first word semantic vector list 122 and the second word semantic vector list 123 which are stored in the memory 102, the auxiliary storage device 103, or the register or cache memory in the processor 101, so as to generate an input-error word list 128.

The present embodiment focuses on a fact that a specification is generated in development of a system to be analyzed by the information system automatic analysis device, and proposes an input error detection scheme that does not depend on the format of the input information and does not require an input error detection rule.

This scheme will be described in detail.

Assume that the analysis device input information 111, which is the input information of the information system automatic analysis device, has been generated based on the information existing in the system specification document 117 which is a specification document of the system to be analyzed. Then, even if the information in the system specification document 117 is transformed into information of a different format such as a sentence, numerical values, and images by the user's operation of generating the analysis device input information 111, it is expectable that information defined essentially forms a subset of the information existing in the system specification document 117.

Inversely speaking, if information not existing in the system specification document 117 does exist in the analysis device input information 111, this means that the state of the system to be analyzed is not correctly reflected, that is, an input error exists.

In the present embodiment, for the purpose of comparing the information in the system specification document 117 and the information in the analysis device input information 111, first, the analysis device input information 111 is converted into a natural language sentence having an equivalent content that explains the information in the analysis device input information 111.

For example, in a case where a block diagram illustrating a state “a device A and a device B are connected via a communication channel C” is defined in the analysis device input information 111, this information is converted into a natural language sentence “a device A and a device B are connected via a communication channel C”.

If an input error occurs and the analysis device input information 111 does not correctly reflect the information existing in the system specification document 117, it is predicted that a word whose meaning has changed from the original meaning exists in the analysis device input information 111 converted into the natural language sentence.

A word meaning mentioned here refers to a meaning that is based on the distributional hypothesis. The distributional hypothesis is a hypothesis that “linguistic items with similar meanings tend to appear in contexts that form similar distributions” [Harris 1954].

If the above example corresponds to an input error and is described as “a device A and a device B are connected via a communication channel D” in the system specification document 117, the term “communication channel C” does not appear in contexts “device A” and “device B” that should appear originally. Hence, it is predicted that a semantic change of “communication channel C” occurs between the system specification document 117 and the analysis device input information 111.

A word related to an input error can be detected by measuring a semantic change of a word as described above.

To measure a semantic change of a word, the system specification document 117 and the analysis device input information 111, which is converted into the natural language sentence, of the information system automatic analysis device are processed with applying natural language processing technology.

In a case where a large quantity of input errors occur and there are many words whose meanings have changed from the original meanings, it is difficult to detect a semantic change of a particular word. Normally, however, an input error occurs only with a low probability and thus does not pose a problem.

In this scheme, not only the analysis device input information 111 but also the analysis device output information 112 which is the output information of the information system automatic analysis device can be used as a material for measuring the semantic change. This is because if the information system analysis device performs an appropriate analysis, the analysis device output information 112 will reflect a content of the analysis device input information 111, so a semantic change of a word due to the input error will be reflected in the analysis device output information 112.

This indicates that in a case where the analysis device input information 111 cannot be easily converted into a natural language sentence, an input error can be detected from the analysis device output information 112 alone.

***Description of Operations***

First, operations of the input error detection device 100 according to the present embodiment will be briefly presented by a mathematical explanation.
1. A list W of frequent common words is extracted from the system specification document 117 and from one or both of the natural-language verbalized analysis device input information 111 and the analysis device output information 112.

W:={w(1),w(2), . . . ,w(n)}
2. For every word w(i) in W, a semantic vector based on the distributional hypothesis is calculated on the system specification document 117 and on one or both of the natural-language verbalized analysis device input information 111 and the analysis device output information 112.
   v(S, w(i)):=word semantic vector of word w(i) learned from system specification document 117
   v(T, w(i)):=word semantic vector of word w(i) learned from one or both of natural-language verbalized analysis device input information 111 and analysis device output information 112
3. An optimum transformation matrix U that satisfies a following expression is calculated:

V(S)·U≈V(T)
where V(S):=matrix whose ith row is v(S, w(i)), V(T):=matrix whose ith row is v(T, w(i))
4. A certain threshold ε>0 is set, and a word w(i) that satisfies the following expression is detected as an input error.

d(ith row of [V(S)·U],V(T,w(i)))>ε
where d(x, y):=distance function

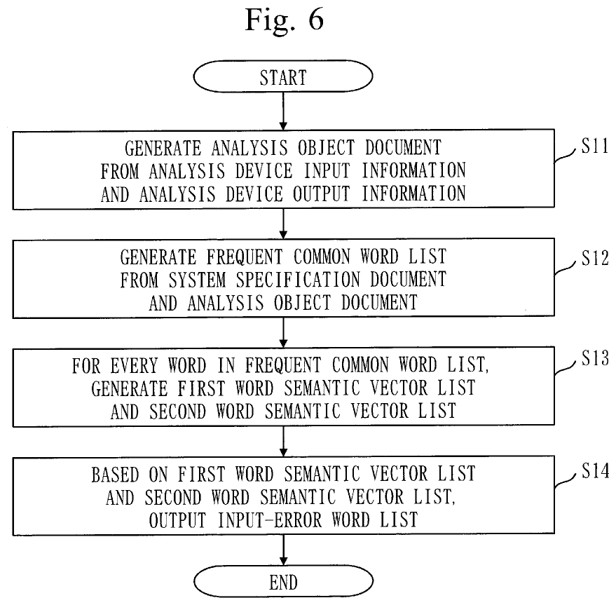

The operations of the input error detection device 100 according to the present embodiment will now be described in detail with referring to FIGS. 6 to 10. The operations of the input error detection device 100 correspond to an input error detection method according to the present embodiment.

FIG. 6 illustrates a flow of the operations of the input error detection device 100.

In step S11, the verbalization unit 107 accepts the analysis device input information 111 and the analysis device output information 112. After that, the verbalization unit 107 converts a content of the analysis device input information 111 and a content of the analysis device output information 112 into natural language sentences, and generates the analysis object document 116 in which the natural language sentences are integrated.

The analysis device input information 111 mentioned here refers to the information to be inputted to the information system automatic analysis device, which includes information generated by a user based on the system specification document 117 and which may include an input error. The analysis device input information 111 may have any format such as numerical values, sentences, and figures; or may be information having a composite format of numerical values, sentences, figures, and so on.

The analysis device output information 112 is a result derived from the analysis device input information 111 on which the information system automatic analysis device had executed some analysis. The analysis device output information 112 may have any format such as numerical values, sentences, and figures; or may be information having a composite format of numerical values, sentences, figures, and so on.

Only one of the analysis device input information 111 and the analysis device output information 112 may be inputted to the verbalization unit 107. When only one of the analysis device input information 111 and the analysis device output information 112 is inputted to the verbalization unit 107, the verbalization unit 107 converts a content of the inputted one between the analysis device input information 111 and the analysis device output information 112 into a natural language sentence, and takes the conversion result as it is, as the analysis object document 116.

In step S12, the selection unit 108 accepts the system specification document 117 to be analyzed by the information system automatic analysis device, and the analysis object document 116 generated by the verbalization unit 107. After that, the selection unit 108 generates lists of words frequently appearing in the system specification document 117 and the analysis object document 116 individually, and identifies words common to the system specification document 117 and the analysis object document 116, thereby generating the frequent common word list 120.

The system specification document 117 is a document generated in a general system development process, which is called, for example, a presentation document, a design specification document, an external specification document, an internal specification document, or an internal/external specification document. A specification document treated by the present embodiment may be any document as far as it is, in a broad sense, “a document which the user who generated the analysis device input information 111 had referred to in defining information of the system, and a document including a word which is employed by the analysis device input information 111 for a word having the same denomination as in the document”.

In step S13, the learning unit 109 accepts the frequent common word list 120 generated by the selection unit 108, the analysis object document 116 generated by the verbalization unit 107, and the system specification document 117. After that, for every word in the frequent common word list 120, the learning unit 109 calculates a semantic vector based on the distributional hypothesis, and generates the first word semantic vector list 122 learned from the system specification document 117 and the second word semantic vector list 123 learned from the analysis object document 116, by labeling each word.

In step S14, the detection unit 110 accepts the first word semantic vector list 122 and the second word semantic vector list 123 which are generated by the learning unit 109. After that, the detection unit 110 identifies an input-error word by calculating a matrix that transforms the first word semantic vector list 122 into the second word semantic vector list 123, and outputs the input-error word list 128.

As described above, in the present embodiment, the verbalization unit 107 transforms at least either one of the analysis device input information 111 which is input information to the analysis devices that analyzes the information system, and the analysis device output information 112 which is output information from the analysis device, into a natural language sentence, so as to generate the analysis object document 116. The analysis object document 116 is a document that describes at least either one of the analysis device input information 111 and the analysis device output information 112, in a natural language. Desirably, the verbalization unit 107 integrates a natural language sentence obtained by converting the analysis device input information 111 and a natural language sentence obtained by converting the analysis device output information 112, so as to generate the analysis object document 116.

The selection unit 108 selects a group of words that appear common to the system specification document 117 and the analysis object document 116. The system specification document 117 is a document that describes a specification of the information system in a natural language. Specifically, the selection unit 108 selects a word that appears in the system specification document 117 and the analysis object document 116 at a frequency exceeding a threshold, as a word belonging to the group of words. The group of words selected by the selection unit 108 are recorded on the frequent common word list 120.

The learning unit 109 learns a meaning of an individual word which exists in each of the system specification document 117 and the analysis object document 116, and which belongs to the group of words selected by the selection unit 108. Specifically, the learning unit 109 generates a first group of vectors which express, per word, meanings of the group of words in the system specification document 117, and a second group of vectors which express, per word, meanings of the group of words in the analysis object document 116, so as to learn the meaning of the individual word in each of the system specification document 117 and the analysis object document 116. The first group of vectors generated by the learning unit 109 are recorded on the first word semantic vector list 122. The second group of vectors generated by the learning unit 109 are recorded on the second word semantic vector list 123.

The detection unit 110 detects a change, between the system specification document 117 and the analysis object document 116, in meaning learned by the learning unit 109, so as to identify a word error being included in the analysis object document 116 and resulting from an input error of the analysis device input information 111. Specifically, the detection unit 110 calculates the transformation matrix U approximating a matrix that transforms the first group of vectors into the second group of vectors, and compares, per word, the second group of vectors with a third group of vectors obtained by transforming the first group of vectors using the calculated transformation matrix U, so as to detect the change between the system specification document 117 and the analysis object document 116. The third group of vectors are recorded on a third word semantic vector list. A word whose error resulting from an input error has been identified by the detection unit 110 is recorded on the input-error word list 128.

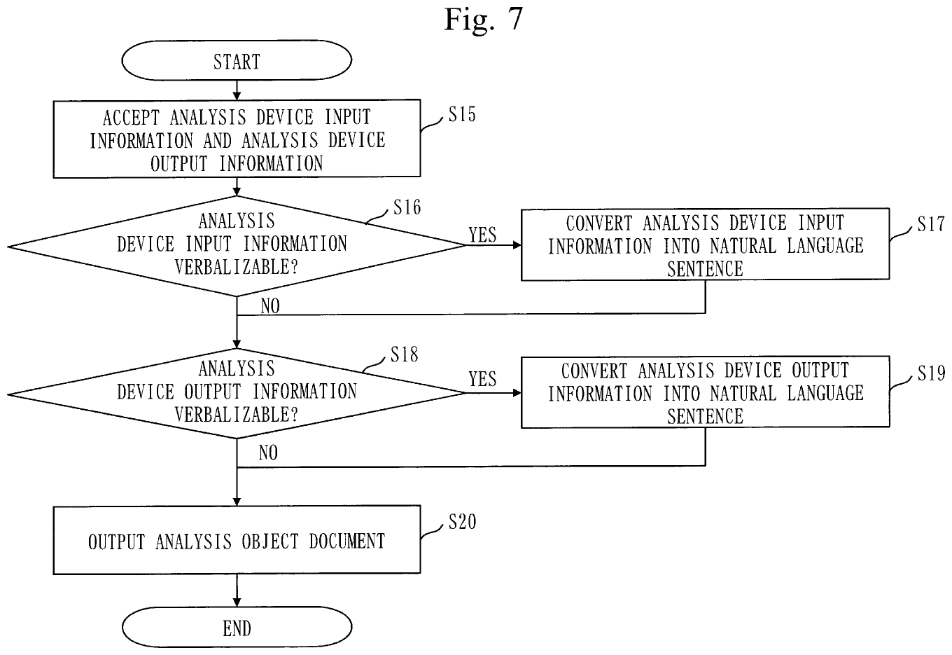

FIGS. 7 to 10 illustrate operations of processes in FIG. 6 in detail. FIGS. 7, 8, 9, and 10 illustrate steps S11, S12, S13, and S14, respectively in detail.

Operations of the verbalization unit 107 in step S11 will be described with referring to FIG. 7.

In step S15, the verbalization unit 107 accepts the analysis device input information 111 and the analysis device output information 112.

In step S16, if the analysis device input information 111 is automatically convertible into a natural language sentence, then in step S17, the input information comprehension unit 113 takes charge of this conversion. Specifically, the input information comprehension unit 113 performs a process of extracting information concerning the system to be analyzed, from the inputted analysis device input information 111, and natural-language verbalizing the extracted information.

When the analysis device input information 111 has a format close to that of a natural language, natural-language verbalization is performed by simple document tailoring. When the analysis device input information 111 has a format much different from that of a natural language, a following process, for example, is performed to natural-language verbalize a content of the analysis device input information 111.

In the case of a table format, information per row of a table is natural-language verbalized into a patterned sentence or the like. At this time, individual rows of the table are natural-language verbalized as independent sentences such that words not related to each other on the table will not be included in one sentence.

In the case of an image format, a content of an image is natural-language verbalized with using an image recognition technology or the like. At this time, preferably, the content to be natural-language verbalized describes a relationship between a subject and movement in the image properly. Alternatively, the content to be natural-language verbalized may simply enumerate names of objects in the image. When there are a plurality of images, the individual images are natural-language verbalized such that objects of different images will not be included in one sentence, and are expressed as independent sentences such that meanings of the individual images will not be mixed up.

In step S18, if the analysis device output information 112 is automatically convertible into a natural language sentence, then in step S19, the output information comprehension unit 114 takes charge of this conversion. Specifically, the output information comprehension unit 114 performs a process of extracting information concerning the system to be analyzed, from the inputted analysis device output information 112, and natural-language verbalizing the extracted information.

When the analysis device output information 112 has a format close to that of a natural language, natural-language verbalization is performed by simple document tailoring. When the analysis device output information 112 has a format much different from that of a natural language, a following process, for example, is performed to natural-language verbalize a content of the analysis device output information 112.

In the case of a table format, information per row of a table is natural-language verbalized into a patterned sentence or the like. At this time, individual rows of the table are natural-language verbalized as independent sentences such that words not related to each other on the table will not be included in one sentence.

In the case of an image format, a content of an image is natural-language verbalized with using an image recognition technology or the like. At this time, preferably, the content to be natural-language verbalized describes a relationship between a subject and movement in the image properly. Alternatively, the content to be natural-language verbalized may simply enumerate names of objects in the image. When there are a plurality of images, the individual images are natural-language verbalized such that objects of different images will not be included in one sentence, and are expressed as independent sentences such that meanings of the individual images will not be mixed up.

In step S16 and step S18, if the analysis device input information 111 and the analysis device output information 112 cannot be automatically converted into natural language sentences, the analysis object document 116 may be generated manually. That is, natural-language verbalization processing of the analysis device input information 111 may be executed manually. Likewise, natural-language verbalization processing of the analysis device output information 112 may be executed manually.

If either one of the analysis device input information 111 and the analysis device output information 112 is difficult to natural-language verbalize, the analysis object document 116 may be generated with natural-language verbalizing information of only either one. In that case, however, learning data to learn meaning lacks in the learning unit 109, and an input error detection accuracy may decrease. Therefore, it is desirable to natural-language verbalize both the information of the analysis device input information 111 and the information of the analysis device output information 112.

The order of processes of steps S16 and S17 and processes of steps S18 and S19 may be inverted.

In step S20, the integrating/tailoring unit 115 integrates the natural-language verbalized analysis device input information 111 and the analysis device output information 112 and outputs the analysis object document 116. That is, the integrating/tailoring unit 115 generates the analysis object document 116 in which information of the system to be analyzed, being obtained from the analysis device input information 111 which is natural-language verbalized by the input information comprehension unit 113, and information of the system to be analyzed, being obtained from the analysis device output information 112 which is natural-language verbalized by the output information comprehension unit 114, are integrated into one document.

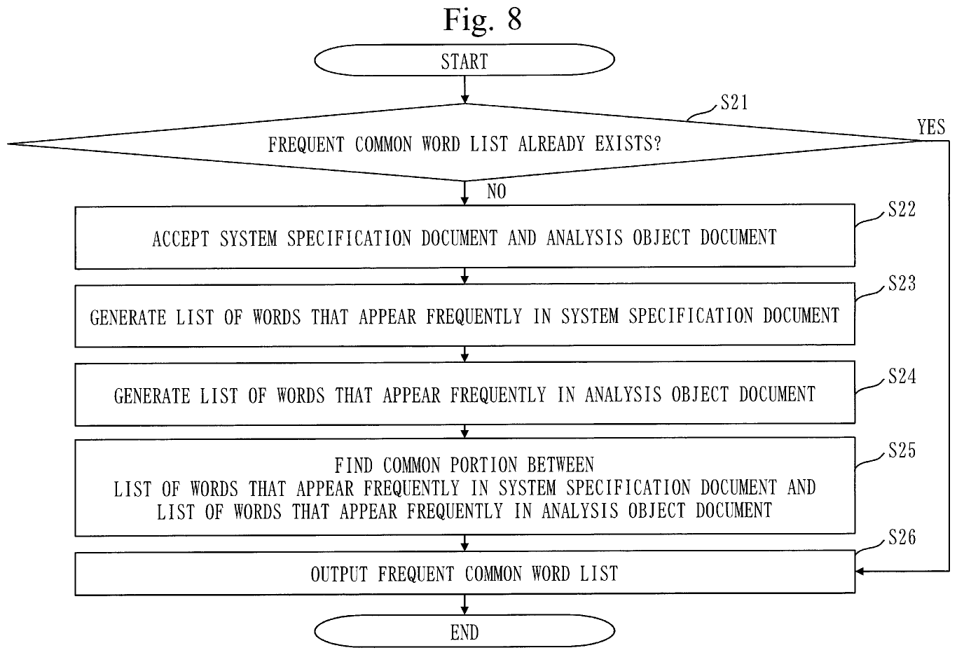

Operations of the selection unit 108 in step S12 will be described with referring to FIG. 8.

In step S21, if a list of words that are candidates to be detected as input errors has been presented by the user or the developer and stored in the memory 102 or the auxiliary storage device 103, then, in step S26, the selection unit 108 outputs the list as the frequent common word list 120.

In step S22, the selection unit 108 accepts the system specification document 117 and the analysis object document 116.

In step S23, the frequent word extraction unit 118 generates a list of words that appear frequently in the system specification document 117. Here, words that are appropriate as frequent words are limited to those that characterize the corresponding document. Universal words and so on that appear frequently in a normal document are excluded.

In step S24, the frequent word extraction unit 118 generates a list of words that appear frequently in the analysis object document 116. Here, words that are appropriate as frequent words are limited to those that characterize the corresponding document. Universal words and so on that appear frequently in a normal document are excluded.

In processes of step S23 and S24, the TF-IDF scheme may be utilized.

In step S25, the common word identification unit 119 identifies words that are common to the list generated in step S23 and the list generated in S24, to thereby generate the frequent common word list 120.

In step S26, the common word identification unit 119 outputs the generated frequent common word list 120.

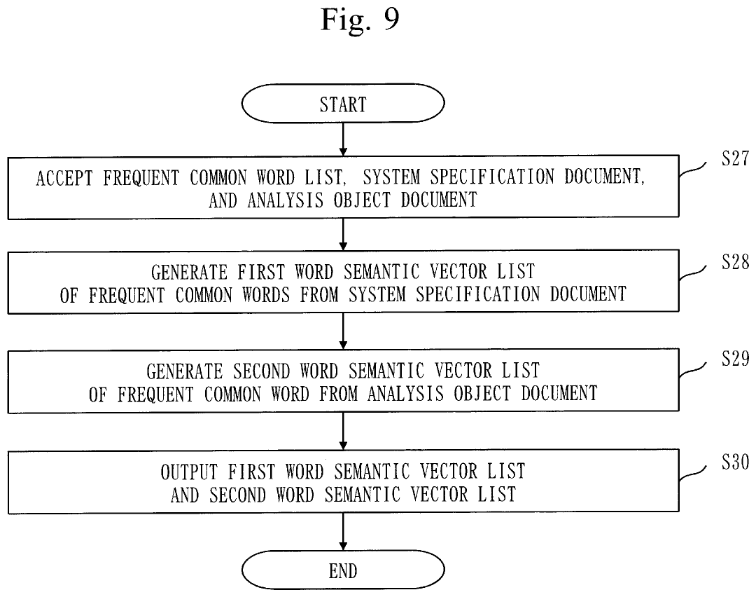

Operations of the learning unit 109 in step S13 will be described with referring to FIG. 9.

In step S27, the learning unit 109 accepts the frequent common word list 120, the system specification document 117, and the analysis object document 116.

In step S28 and step S29, for every word existing in the frequent common word list 120, the semantic vector generation unit 121 calculates a semantic vector based on the distributional hypothesis. The semantic vector generation unit 121 generates the first word semantic vector list 122 learned from the system specification document 117 and the second word semantic vector list 123 learned from the analysis object document 116, by labeling each word. A number of dimensions of the first word semantic vector list 122 and a number of dimensions of the second word semantic vector list 123 need not match.

As a natural language technique which gives a semantic vector based on the distributional hypothesis in order to realize processing of the semantic vector generation unit 121, word2vec, Latent Semantic Indexing, Ransom Indexing, or the like can be employed. The natural language technique is not limited to those enumerated here, but any technique can be used as far as it is a natural language technique based on the distributional hypothesis to generate a feature amount vector of multi-dimensional meaning, that is, a distributed representation.

In the present embodiment, a change in relative semantic relationship between words is detected from matching in fitting of matrix transformation, and an input-error word is detected. Hence, as a scheme that gives a semantic vector, it is preferable to employ word2vec with which semantic additive structures are formed in semantic vectors of a word.

The order of the process of step S28 and the process of step S29 may be inverted.

In step S30, the semantic vector generation unit 121 outputs the first word semantic vector list 122 and the second word semantic vector list 123.

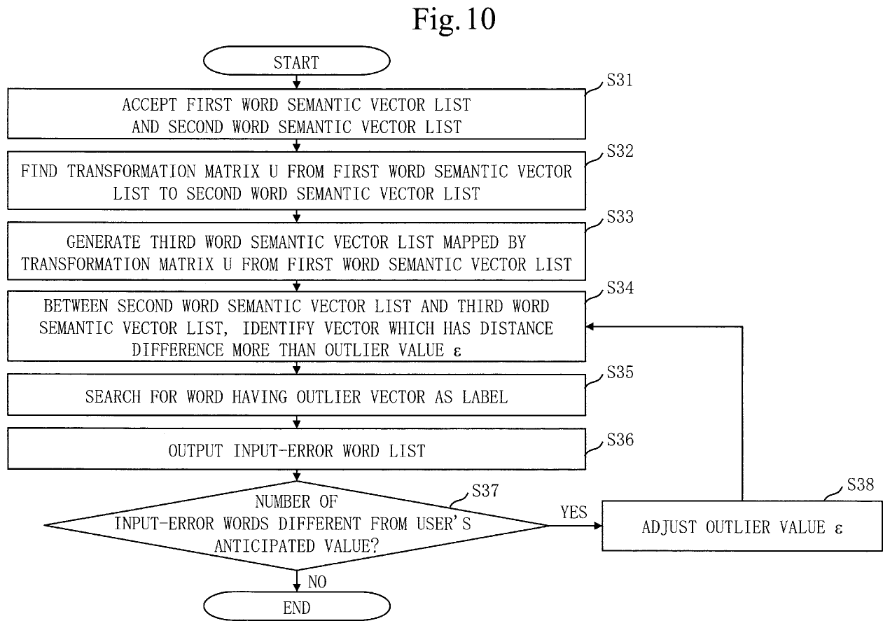

Operations of the detection unit 110 in step S14 will be described with referring to FIG. 10.

In step S31, the detection unit 110 accepts the frequent common word list 120, the first word semantic vector list 122, and the second word semantic vector list 123.

In step S32, the transformation matrix calculation unit 124 finds an optimum transformation matrix U that transforms the first word semantic vector list 122 into the second word semantic vector list 123.

In step S33, the outlier vector extraction unit 125 generates a third word semantic vector list which is an image mapped from the first word semantic vector list 122 by the matrix U.

In step S34, based on a quite small positive value c given in advance, the outlier vector extraction unit 125 extracts an outlier vector in the first word semantic vector list 122 which has distance difference more than c between a vector in the third word semantic vector list and a vector in the second word semantic vector list 123. As the distance, in addition to Euclidean distance, any distance such as cosine angle can be employed as far as it enables comparison between multi-dimensional real-value vectors. Also, a pseudometric, an antimetric, or the like can be employed in place of a strict distance.

In step S35 and step S36, the corresponding-to-vector word search unit 127 identifies a word having an outlier vector as a label, and outputs the word as the input-error word list 128.

If, in step S37, there are too many words included in the input-error word list 128, then in step S38, under an assumption that an input error occurs with a low probability, the outlier value adjustment unit 126 adjusts the value E. Then, processes of step S34 to step S36 are repeated, and the input-error word list 128 with an appropriate number of words is outputted.

### Description of Effect of Embodiment

In the present embodiment, the meaning of an individual word belonging to the group of words that appear common to the system specification document 117 and the analysis object document 116 is learned. Then, a change in learned meaning between the system specification document 117 and the analysis object document 116 is detected, so that a word error included in the analysis object document 116 and resulting from an input error of the analysis device input information 111 is identified. Therefore, according to the present embodiment, an input error detection scheme can be provided that does not depend on the format of the analysis device input information 111 and does not require an input error detection rule.

In the present embodiment, the verbalization unit 107 converts the contents of the input information and output information of the information system automatic analysis device into natural language sentences and integrates the converted contents, to thereby generate the analysis object document 116 for input error detection. The selection unit 108 selects a group of words that frequently appear common to the system specification document 117 and the analysis object document 116. The learning unit 109 learns a meaning of every word belonging to the group of frequent common words, in the system specification document 117 and the analysis object document 116 based on individual distributional hypotheses. The detection unit 110 detects a semantic change caused by an input error and identifies a word supposed to be an input error, from the group of frequent common words.

According to the present embodiment, it is possible to identify an input error existing on the input information of the information system automatic analysis device, and to feed back a list of words supposed to be input errors, automatically to the user. Different from the conventional input error detection scheme, the developer need not prepare an input error detection rule that “what state corresponds to an input error”, so that the development cost of the input interface of the information system automatic analysis device can be reduced. Also, it is expected that since occasions where analysis is performed with an input error being included are reduced, reworking and malfunctioning in the system development which result from an incorrect analysis result are reduced.

In addition, the characteristic of the present embodiment that the existence of an input error is detected from a viewpoint of a semantic change of a word by converting a content of input information once entirely into a natural language sentence, provides an effect of enabling detection of the input error even if the format of the input information to the analysis device varies, as with numerical values, images, and documents.

In this manner, in the present embodiment, it is possible to automatically detect an input error that can occur when the user manually generates input information to the information system automatic analysis device which assesses a state of the information system. A detected input error is fed back to the user. Input error detection is executed by converting first the input information into a natural language sentence having an equivalent content, and by checking a difference existing in a specification document of the system to be analyzed, that is, by checking whether a semantic change of a word occurs, with applying the natural language processing technology which is based on the distributional hypothesis. By the effect of the present embodiment, the cost of developing a rule for input error detection can be reduced, and generation of accurate input information by the user can be aided.

### OTHER CONFIGURATIONS

In the present embodiment, the functions of the verbalization unit 107, selection unit 108, learning unit 109, and detection unit 110 are implemented by software. In a modification, the functions of the verbalization unit 107, selection unit 108, learning unit 109, and detection unit 110 may be implemented by a combination of software and hardware. That is, some of the functions of the verbalization unit 107, selection unit 108, learning unit 109, and detection unit 110 may be implemented by dedicated hardware, and the remaining functions may be implemented by software.

The dedicated hardware is, for example, a single circuit, a composite circuit, a programmed processor, a parallel-programmed processor, a logic IC, a GA, an FPGA, or an ASIC; or a combination of some or all of a single circuit, a composite circuit, a programmed processor, a parallel-programmed processor, a logic IC, a GA, an FPGA, and an ASIC. Note that IC stands for Integrated Circuit, GA for Gate Array, FPGA for Field-Programmable Gate Array, and ASIC for Application Specific Integrated Circuit.

Both the processor 101 and the dedicated hardware are processing circuitry. That is, regardless of whether the functions of the verbalization unit 107, selection unit 108, learning unit 109, and detection unit 110 are implemented by software, or by a combination of software and hardware, the operations of the verbalization unit 107, selection unit 108, learning unit 109, and detection unit 110 are performed by processing circuitry.

### REFERENCE SIGNS LIST

100: input error detection device; 101: processor; 102: memory; 103: auxiliary storage device; 104: communication device; 105: input apparatus; 106: display; 107: verbalization unit; 108: selection unit; 109: learning unit; 110: detection unit; 111: analysis device input information; 112: analysis device output information; 113: input information comprehension unit; 114: output information comprehension unit; 115: integrating/tailoring unit; 116: analysis object document; 117: system specification document; 118: frequent word extraction unit; 119: common word identification unit; 120: frequent common word list; 121: semantic vector generation unit; 122: first word semantic vector list; 123: second word semantic vector list; 124: transformation matrix calculation unit; 125: outlier vector extraction unit; 126: adjustment unit; 127: corresponding-to-vector word search unit; 128: input-error word list.

1. An input error detection device comprising:
processing circuitry
to select a group of words that appear common to a system specification document describing a specification of an information system in a natural language, and an analysis object document describing at least either one of input information to an analysis device that analyzes the information system and output information from the analysis device in a natural language,
to learn a meaning of an individual word in each of the system specification document and the analysis object document, wherein the individual word belongs to the selected group of words, and
to detect a change, between the system specification document and the analysis object document, in learned meaning, so as to identify a word error being included in the analysis object document and resulting from an input error of the input information.

2. The input error detection device according to claim 1,
wherein the processing circuitry
generates a first group of vectors which express, per word, meanings of the group of words in the system specification document, and a second group of vectors which express, per word, meanings of the group of words in the analysis object document, so as to learn the meaning of the individual word in each of the system specification document and the analysis object document, and
calculates a transformation matrix approximating a matrix that transforms the first group of vectors into the second group of vectors, and compares, per word, the second group of vectors with a third group of vectors obtained by transforming the first group of vectors using the calculated transformation matrix, so as to detect the change between the system specification document and the analysis object document.

3. The input error detection device according to claim 1, wherein the processing circuitry transforms at least either one of the input information and the output information into a natural language sentence, so as to generate the analysis object document.

4. The input error detection device according to claim 2, wherein the processing circuitry transforms at least either one of the input information and the output information into a natural language sentence, so as to generate the analysis object document.

5. The input error detection device according to claim 3,
wherein the processing circuitry integrates a natural language sentence obtained by converting the input information and a natural language sentence obtained by converting the output information, so as to generate the analysis object document.

6. The input error detection device according to claim 4,
wherein the processing circuitry integrates a natural language sentence obtained by converting the input information and a natural language sentence obtained by converting the output information, so as to generate the analysis object document.

7. The input error detection device according to claim 1,
wherein the processing circuitry selects a word that appears in each of the system specification document and the analysis object document at a frequency exceeding a threshold, as a word belonging to the group of words.

8. The input error detection device according to claim 2,
wherein the processing circuitry selects a word that appears in each of the system specification document and the analysis object document at a frequency exceeding a threshold, as a word belonging to the group of words.

9. The input error detection device according to claim 3,
wherein the processing circuitry selects a word that appears in each of the system specification document and the analysis object document at a frequency exceeding a threshold, as a word belonging to the group of words.

10. The input error detection device according to claim 4,
wherein the processing circuitry selects a word that appears in each of the system specification document and the analysis object document at a frequency exceeding a threshold, as a word belonging to the group of words.

11. The input error detection device according to claim 5,
wherein the processing circuitry selects a word that appears in each of the system specification document and the analysis object document at a frequency exceeding a threshold, as a word belonging to the group of words.

12. The input error detection device according to claim 6,
wherein the processing circuitry selects a word that appears in each of the system specification document and the analysis object document at a frequency exceeding a threshold, as a word belonging to the group of words.

13. An input error detection method comprising:
selecting a group of words that appear common to a system specification document describing a specification of an information system in a natural language, and an analysis object document describing at least either one of input information to an analysis device that analyzes the information system and output information from the analysis device in a natural language;
learning a meaning of an individual word in each of the system specification document and the analysis object document, wherein the individual word belongs to the selected group of words; and
detecting a change, between the system specification document and the analysis object document, in learned meaning, so as to identify a word error being included in the analysis object document and resulting from an input error of the input information.

14. A non-transitory computer readable medium recorded with an input error detection program which causes a computer to execute:
a selection process of selecting a group of words that appear common to a system specification document describing a specification of an information system in a natural language, and an analysis object document describing at least either one of input information to an analysis device that analyzes the information system and output information from the analysis device in a natural language;
a learning process of learning a meaning of an individual word in each of the system specification document and the analysis object document, wherein the individual word belongs to the group of words selected by the selection process; and
a detection process of detecting a change, between the system specification document and the analysis object document, in meaning learned by the learning process, so as to identify a word error being included in the analysis object document and resulting from an input error of the input information.
